(19) United States
(12) Patent Application Publication
(10) Pub. No.: US 2005/0084670 A1
(43) Pub. Date: Apr. 21, 2005

(54) Pressure-sensitive adhesive type optical film and image display

(76) Inventors: Masayuki Satake, Osaka (JP); Shigeo Kobayashi, Osaka (JP); Michio Umeda, Osaka (JP); Chiaki Harada, Osaka (JP); Naoki Sadayori, Osaka (JP); Hideki Akamatsu, Osaka (JP); Akiko Ogasawara, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/502,937

(22) PCT Filed: Jan. 28, 2003
(86) PCT No.: PCT/JP03/00787

(30) Foreign Application Priority Data
Feb. 1, 2002 (JP) 2002-025515
Feb. 1, 2002 (JP) 2002-025580
Jan. 24, 2003 (JP) 2003-015910

(51) Int. Cl. B32B 7/12; B32B 15/04

(52) U.S. Cl. 428/343; 428/354; 428/355 R

(57) ABSTRACT

A pressure-sensitive adhesive type optical film which comprises an optical film and a pressure-sensitive adhesive layer superposed on at least one side thereof through an anchor layer formed from a resin emulsion. It is easy to handle because the pressure-sensitive adhesive does not peel off even when an edge of the film comes into contract during handling in use.

### FIELD OF THE INVENTION

The present invention relates to a pressure sensitive adhesive optical film having a pressure sensitive adhesive layer laminated on at least one surface of the optical film. Specifically, it relates to an image viewing display using the pressure sensitive adhesive optical film, such as liquid crystal displays, organic EL displays, and PDPs. As the optical films, polarizing plates, retardation plates, optical compensating films, brightness enhancement films, etc., and furthermore optical films with the films laminated to each other may be mentioned.

### BACKGROUND ART

In liquid crystal displays etc., an image forming system necessarily requires polarizing elements disposed on both sides of a liquid crystal cell, and, in general, polarizing plate(s) are adhered thereto. Moreover, in liquid crystal panels, in order to improve display quality of displays, various optical elements other than polarizing plates are increasingly used. For example, retardation plates for prevention of coloring, viewing-angle expansion films for improving viewing angle of liquid crystal displays, and furthermore, brightness enhancement films for increasing contrast of displays etc. are used. These films are generically called optical films.

In case of adhesion of the above-mentioned optical films to liquid crystal cells, pressure sensitive adhesives are usually used. Moreover, in adhesion between optical films and liquid crystal cells, and between optical films, each material is usually attached by using pressure sensitive adhesives in order to reduce loss of light. In such a case, since it has such advantage that does not require drying stages for firm adhesion of the optical films, there are generally used pressure sensitive adhesive optical films having a pressure sensitive adhesive beforehand prepared on one side of the optical films as a pressure sensitive adhesive layer.

The pressure sensitive adhesive optical film is cut into a size of a display in use. Contact of an end (cut end) of the pressure sensitive adhesive optical film to a people and an equipment may cause omission of the pressure sensitive adhesive in a contact portion in case of handling in the process for the use. Since attachment on a liquid crystal cell of a pressure sensitive adhesive optical film with omission of a pressure sensitive adhesive disables adhesion of the omitted portion, the portion reflects light, and as a result there may occur a problem of a display defect. Recently an edge of a display is required especially to be narrower and then a defect generated at the end markedly reduces display quality.

The present invention aims at providing a pressure sensitive adhesive optical film in which a pressure sensitive adhesive layer(s) is laminated on at least one surface of the optical film, wherein the pressure sensitive adhesive optical film does not cause omission of the pressure sensitive adhesive by contact of an end thereof in case of handling in the process for the use, and provides easy handling.

Furthermore, it aims at providing an image viewing display using the pressure sensitive adhesive optical film concerned.

### DESCRIPTION OF THE INVENTION

As a result of wholehearted research made by the present inventors in order to solve the above-mentioned problems, it was found out that the object might be attained using a following pressure sensitive adhesive optical film, thus leading to completion of the present invention.

That is, the invention relates to a pressure sensitive adhesive optical film with a pressure sensitive adhesive layer laminated on at least one surface of an optical film, wherein the pressure sensitive adhesive layer is laminated through an anchor layer formed of resin emulsions.

In a pressure sensitive adhesive optical film of the invention, based on a consideration that omission of pressure sensitive adhesives originates mainly in a low adhesive properties between a pressure sensitive adhesive layer and an optical film base material, it has become possible that intervention of an anchor layer formed of resin emulsions between the pressure sensitive adhesive layer and the optical film base material improves adhesive properties between the pressure sensitive adhesive layer and the optical film. This can greatly reduce partial omission of the pressure sensitive adhesives at a film end in case of handling of the pressure sensitive adhesive optical film, and also can improve handling property of the pressure sensitive adhesive optical film. Moreover, resin emulsions can form a pressure sensitive adhesive layer, without changing in quality of the optical film concerned, when materials of the optical film have inferior solvent resistance. For example, in the pressure sensitive adhesive optical film, also when materials of the optical film surface on which an anchor layer is laminated are of polycarbonate and norbornene based resins, change in quality of material may be suppressed.

In the pressure sensitive adhesive optical film, the anchor layer preferably has a thickness not less than twice of mean particle diameter of the resin emulsions. Moreover, a thickness of the anchor layer is set so as to give a value of not less than twice a mean particle diameter of the resin emulsion used for formation material of the anchor layer, which can give a sufficient strength for the anchor layer, and thereby can improve adhesive properties. A thickness of the anchor layer of less than twice of the mean particle diameter of the resin emulsions cannot give a sufficient strength, resulting in inadequate adhesive properties. A thickness of the anchor layer is preferably not less than 4 times of a mean particle diameter of the resin emulsions, and more preferably not less than 6 times. In addition, since an excessive thickness of the anchor layer may have adverse influence on adhesive physical properties, it is usually preferably not more than 500 times of a mean particle diameter of the resin emulsions.

In the pressure sensitive adhesive optical film, it is preferable that a thickness of the anchor layer is not less than 100 nm. When a thickness of the anchor layer becomes thinner, it may no longer have a character as bulk material, but fails to show a sufficient strength, and as a result sometimes sufficient adhesive properties may not be obtained. A thickness of the anchor layer is preferably not less than 100 nm, more preferably not less than 200 nm, and still more preferably not less than 250 nm. In addition, a thickness of the anchor layer is usually preferably not more than 3 μm in view of optical characteristics.

Preferable embodiment is that in the pressure sensitive adhesive optical film, resin emulsions are of ethyleneimine addition products and/or polyethylene imine addition products of acrylic based polymer emulsions, and a base polymer of a pressure sensitive adhesive for forming a pressure sensitive adhesive layer includes functional groups reactive with amino groups.

Acrylic based polymer emulsions used for formation materials of an anchor layer comprise resin beads synthesized by emulsion polymerization, and by converting the beads to ethyleneimine addition products and/or polyethylene imine addition products, primary amino groups may be effectively unevenly distributed in a resin beads surface portion. On the other hand, in the pressure sensitive adhesive for forming the pressure sensitive adhesive layer, a pressure sensitive adhesive including functional groups reactive with amino groups is used as a base polymer, and thereby in a surface boundary and vicinity between the anchor layer and the pressure sensitive adhesive layer, amino groups of in the anchor layer and functional groups in the pressure sensitive adhesive layer may react with each other to enable formation of a firm adhesive properties between the anchor layer and the pressure sensitive adhesive layer. And since the resin beads are synthesized by emulsion polymerization and have high rate of polymerization and high force of coagulation of the resin, as a result, they exhibit outstanding mechanical strength, which is effective in preventing pressure sensitive adhesive omission also from this point view.

In addition, an example is known that an anchor layer of an ethyleneimine addition product of a polyacrylic ester is prepared as an anchor layer between a pressure sensitive adhesive layer and an optical film base material (Japanese Patent Laid-Open No. 10-20118 official report). However, the resin that forms the anchor layer is a solvent type resin, in the above-mentioned example, and even if ethyleneimine is added to the resin, only primary amine may be introduced into the resin, which does not provide a structure enabling uneven distribution of the primary amine on a bead surface thereof as in the invention. Moreover, the polyacrylic ester portion does not work effectively for adhesive properties with the base material. Therefore, it may not be understood that the anchor layer given in the official report can fully improve the adhesive properties between the pressure sensitive adhesive layer and the optical film base material. Furthermore, since the ethyleneimine addition product of the polyacrylic ester requires coating in a state of being diluted with organic solvents, the organic solvent will adversely affect the materials, when the optical film materials are of polycarbonate and norbornene based resins.

A preferable embodiment of the invention is that functional groups reactive with amino groups included in a base polymer of a pressure sensitive adhesive for forming the pressure sensitive adhesive layer are of a carboxyl group. Carboxyl groups have excellent reactivity with amino groups and are suitable as the functional groups included in the base polymer, and moreover provide excellent adhesive properties between the pressure sensitive adhesive layer and the anchor layer.

A preferable embodiment of the invention is that the acrylic based polymer emulsions are of acrylic/styrene copolymer emulsions. Copolymer emulsions of styrene based monomers as monomers constituting the acrylic based polymer emulsions enables further improvement in mechanical strength.

Moreover, a preferable embodiment of the invention is that the above-mentioned resin emulsions are emulsions of polyurethane resins in the pressure sensitive adhesive optical film. Moreover, glass transition temperature (Tg) of the polyurethane resins is preferably not more than −30° C. Polyurethane resins advantageously have high flexibility in molecular designing, and moreover, the resins having glass transition temperature of not more than −30° C. have excellent diffusibility in the pressure sensitive adhesive layer, which may exhibit excellent autohesion effect between emulsion particles.

Moreover, in the pressure sensitive adhesive optical film, an optical film preferably has activation treatment performed thereto. Activation treatment given to the optical film can suppress crawling at the time of formation of the anchor layer onto the optical film, which enables easy formation of the anchor layer with excellent adhesive properties on the optical film.

Moreover, the invention relates to an image viewing display using the at least one pressure sensitive adhesive optical films. According to various kinds of utilization embodiments of the image viewing displays, such as liquid crystal displays, the pressure sensitive adhesive optical films of the invention may be used independently or two or more of them may be used in combination.

### BRIEF DESCRIPTION OF THE DRAWINGS

FIG. 1 is a cross-sectional view of a pressure sensitive adhesive optical film of the present invention; and

FIG. 2 is a cross-sectional enlarged view of a pressure sensitive adhesive optical film of the invention.

### BEST MODE FOR CARRYING-OUT OF THE INVENTION

As pressure sensitive adhesives for forming a pressure sensitive adhesive layer of a pressure sensitive adhesive optical film of the present invention, various kinds of pressure sensitive adhesives, such as rubber based pressure sensitive adhesives, acrylic based pressure sensitive adhesives, and silicone based pressure sensitive adhesives, may be used. In general, acrylic based pressure sensitive adhesives having colorless transparency and excellent adhesive property with liquid crystal cells etc. are used.

Acrylic based pressure sensitive adhesives have, as a base polymer, acrylic polymers having a monomer unit of alkyl (meth)acrylate as a principal skeleton. In addition, (meth)acrylate represents acrylate and/or methacrylate and (meth) used in the invention has a same meaning. An average carbon number of alkyl groups of alkyl (meth)acrylates that constitute a principal skeleton of the acrylic polymer is about 1 to 12, and as examples of alkyl (meth)acrylates, there may be mentioned: methyl (meth)acrylates, ethyl (meth)acrylates, butyl (meth)acrylates, 2-ethyl hexyl (meth)acrylates, etc. These may be used independently, or may be used in combination. Among them, alkyl (meth)acrylates of alkyl groups of carbon numbers of 1 to 7 are preferable.

Various functional groups may be introduced into the base polymer such as acrylic polymers. When resin emulsions having amino groups, such as ethyleneimine addition products and/or polyethylene imine addition products of acrylic based polymer emulsions, are used as resin emulsions of the anchor layer, functional groups reactive with amino groups are used as the functional groups. As functional groups reactive with amino groups, for example, carboxyl group, epoxy group, isocyanate group, etc. may be mentioned. Moreover, a preferable embodiment is that when using resin emulsions having isocyanate group at end groups, such as polyurethane resins, as a resin emulsion, a base polymer of the pressure sensitive adhesive that forms a pressure sensitive adhesive layer includes functional groups reactive with isocyanate group, such as amino group, carboxyl group, and hydroxyl group. Carboxyl group is suitable among these functional groups. Acrylic polymers having the functional groups include monomer units having the functional groups concerned.

As monomers having carboxyl group, acrylic acid, methacrylic acid, fumaric acid, maleic acid, itaconic acid, etc. may be mentioned. Glycidyl (meth)acrylates etc. may be mentioned as monomers including epoxy groups. As monomers having hydroxyl group, monomers including hydroxyl group, such as 2-hydroxy ethyl (meth)acrylate and N-methylol (meth)acrylamide; hydroxy butyl (meth)acrylate; hydroxy hexyl (meth)acrylate etc. may be mentioned. Furthermore, as monomers including N element, there may be mentioned: (meth)acrylamide, N,N-dimethyl (meth)acrylamide, N,N-diethyl (meth)acrylamide, (meth)acryloyl morpholine, (meth)acetonitrile , vinyl pyrrolidone, N-cyclohexyl maleimide, itaconimide, N,N-dimethylamino ethyl (meth)acrylamide etc. In addition, vinyl acetate, styrene, etc. may further be used for the acrylic polymers in a range that does not impair performance of the pressure sensitive adhesives. These monomers may be used independently or two or more kinds of them may be used in combination.

Although a ratio of a monomer unit having the functional groups in the acrylic polymer is not especially limited, a weight ratio (a/A) with a monomer unit (A) (wherein except for the above-mentioned monomer unit (a)) constituting the acrylic polymers is about 0.001 to 0.12, and preferably 0.005 to 0.1.

Although an average molecular weight of the acrylic polymer is not especially limited, a weight average molecular weight (by GPC) is preferably about 300,000 to 2,500,000. The acrylic polymer may be manufactured using suitably selected various well-known methods, for example, radical-polymerization methods, such as a bulk polymerization method, a solution-polymerization method, and a suspension-polymerization method. As radical polymerization initiators, various kinds of well-known azo based and peroxide based polymerization initiators may be used. A reaction temperature is usually about 50 to 85° C., and reaction time is about 1 to 8 hours. Moreover, also among the manufacturing methods, a solution-polymerization method is preferable, and polar solvents, such as ethyl acetate and toluene, are generally used as solvents for acrylic polymers. A solution concentration is usually about 20 to 80% by weight.

As base polymers of rubber based pressure sensitive adhesives, for example, there may be mentioned: natural rubbers, isoprene rubbers, styrene butadiene based rubbers, reclaimed rubbers, polyisobutylene based rubbers, and furthermore styrene-isoprene-styrene based rubbers, styrene-butadiene-styrene based rubbers, etc., and as base polymers of silicone based pressure sensitive adhesives, for example, dimethyl polysiloxanes, diphenyl polysiloxanes, etc. may be mentioned, and polymers into which functional groups reactive with amino groups, such as carboxyl groups are introduced may suitably be used.

Moreover, the pressure sensitive adhesive is preferably a pressure sensitive adhesive composition including crosslinking agents. As polyfunctional compounds that may be blended with the pressure sensitive adhesive, organic crosslinking agents and polyfunctional metal chelates may be mentioned. As organic based crosslinking agents, epoxy based crosslinking agents, isocyanate based crosslinking agents, imine based crosslinking agents, etc. may be mentioned. As organic based crosslinking agents, isocyanate based crosslinking agents are preferable. Polyfunctional metal chelates are substances having polyvalent metals that have a coordinate bond or a covalent bond with organic compounds. As polyvalent metal atoms, Al, Cr, Zr, Co, Cu, Fe, Ni, V, Zn, In, Ca, Mg, Mn, Y, Ce, Sr, Ba, Mo, La, Sn, Ti, etc. may be mentioned. An oxygen atom etc. may be mentioned as an atom in organic compounds constituting a covalent bond or a coordinate bond, and as organic compounds, alkyl esters, alcohol compounds, carboxylic acid compounds, ether compounds, ketone compounds, etc. may be mentioned.

Although a blending ratio of a base polymer, such as acrylic polymers, and a crosslinking agent is not especially limited, but usually, preferably the crosslinking agent (solid content) is about 0.01 to 6 parts by weight to the base polymer (solid content) 100 parts by weight, and more preferably 0.1 to 3 parts by weight.

Furthermore, to the pressure sensitive adhesive, if necessary, there may suitably be used tackifiers, plasticizers, glass fibers, glass beads, fillers comprising metal powders, other inorganic powders, etc., pigments, colorants, fillers, antioxidants, ultraviolet absorbers, silane coupling agents etc. Moreover, various kinds of additives in a range that does not depart from purposes of the invention may also be suitably used. A pressure sensitive adhesive layer showing light diffusibility obtained by adding micro-particles is also employable.

The anchor layer is formed of resin emulsions. As resin emulsions, various kinds of resin emulsions may be used, for example, resin emulsions obtained by emulsion polymerization of acrylic based monomers etc., and furthermore, resin emulsions to which various kinds of denaturation is given to the obtained emulsion polymerized polymers etc. Moreover, as resin emulsions there may be used resin emulsions obtained by emulsifying various kinds of resins, such as polyurethanes and polyesters using emulsifiers, and resin emulsions obtained as a self-emulsified emulsion by introducing water dispersible anion groups, cationic groups, or nonion groups into the above-mentioned resins.

Although a mean particle diameter of the resin emulsions is not especially limited, it is preferably about 5 to 500 nm, and more preferably 10 to 300 nm.

As resin emulsions used for formation of an anchor layer of the invention, for example, ethyleneimine addition products and/or polyethylene imine addition products of acrylic based polymer emulsions may be suitably used. The acrylic based polymer emulsion may be obtained, according to conventional methods, by carrying out emulsion polymerization of alkyl (meth)acrylates and copolymerizable monomers thereof constituting base polymers (acrylic polymers) of the acrylic based pressure sensitive adhesives mentioned above. As copolymerizable monomers, in order to make ethyleneimine etc. react, monomers having functional groups such as carboxyl group etc. may be used. A percentage to be used of monomers having functional groups, such as carboxyl group, is suitably adjusted based on a percentage of such as ethyleneimine to be reacted. Moreover, as copolymerizable monomers, styrene based monomers are preferably used, as mentioned above.

Ethyleneimine and/or polyethylene imines are made to react to the acrylic based polymer emulsions to obtain addition products. By reacting ethyleneimine to carboxyl group in the acrylic based polymer emulsions etc., resins with an amino ethyl group as a primary amine group being grafted at a terminal group may be obtained. Polyethylene imine addition products may be obtained from the ethyleneimine by addition polymerization. Moreover, addition products with polyethylene imine grafted thereto may also be obtained by reacting separately synthesized polyethylene imine to carboxyl groups in acrylic based polymer emulsions etc. In the ethyleneimine addition products and/or polyethylene imine addition products of the acrylic based polymer emulsions, amine hydrogen equivalent is preferably about 300 to 800 g-solid/eq.

Ethyleneimine addition products and/or polyethylene imine addition products of the acrylic based polymer emulsions are not especially limited, but various kinds may be used. For example, as examples of commercially available article, POLYMENT SK-1000 by NIPPON SHOKUBAI Co., Ltd. may be mentioned.

Moreover, as resin emulsions used for formation of the anchor layer, resin emulsions of polyurethanes may suitably be used. Adeka Bontighter HUX series by Asahi Denka Co., Ltd. that is self-emulsified without emulsifiers may be mentioned as resin emulsions of polyurethanes.

Moreover, compounds reactive with resin emulsions may be mixed in addition to the resin emulsions in formation of the anchor layer to form a cross-linking, enabling improvement in strength of the anchor layer. Epoxy compounds etc. may be illustrated as compounds reactive with the resin emulsions.

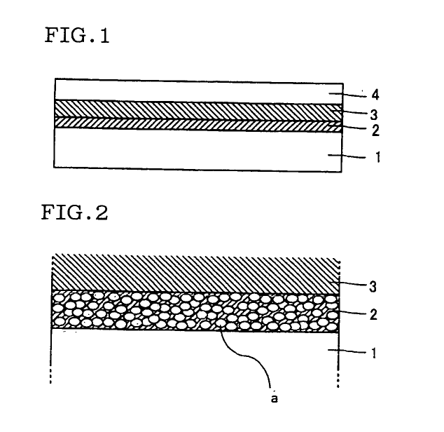

In a pressure sensitive adhesive optical film of the invention, as shown in FIG. 1, a pressure sensitive adhesive layer 3 is formed onto an optical film 1 through the anchor layer 2. Moreover, a releasing sheet 4 may be formed on the pressure sensitive adhesive layer 3.

Films used for formation of a liquid crystal display etc. are used as the optical film 1, and types of the films are not especially limited. As optical films, for example, a polarizing film(polarizing plate), films of types having a transparent protective film are used on one side or both sides of a polarizer.

A polarizer is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol type film, partially formalized polyvinyl alcohol type film, and ethylene-vinyl acetate copolymer type partially saponified film; poly-ene type alignment films, such as dehydrated polyvinyl alcohol and dehydrochlorinated polyvinyl chloride, etc. may be mentioned. In these, a polyvinyl alcohol type film on which dichromatic materials (iodine, dyes) is absorbed and aligned after stretched is suitably used. Although thickness of polarizer is not especially limited, the thickness of about 5 to 80 μm is commonly adopted.

A polarizer that is uniaxially stretched after a polyvinyl alcohol type film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol type film may be dipped in water and rinsed if needed. By rinsing polyvinyl alcohol type film with water, effect of preventing un-uniformity, such as unevenness of dyeing, is expected by making polyvinyl alcohol type film swelled in addition that also soils and blocking inhibitors on the polyvinyl alcohol type film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

As a materials forming the protective film prepared in one side or both sides of the above-mentioned polarizer, with outstanding transparency, mechanical strength, heat stability, moisture cover property, isotropy, etc. may be preferable. As materials of the above-mentioned protective film, for example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming a protective film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; allylate type polymers; polyoxymethylene type polymers; epoxy type polymers; or blend polymers of the above-mentioned polymers may be mentioned. Films made of heat curing type or ultraviolet ray curing type resins, such as acryl based, urethane based, acryl urethane based, epoxy based, and silicone based, etc. may be mentioned.

In general, a thickness of a transparent protective film is 500 μm or more, preferably 1 through 300 μm, and especially preferably 5 through 200 μm.

As a transparent protective film, if polarization property and durability are taken into consideration, cellulose based polymer, such as triacetyl cellulose, is preferable, and especially triacetyl cellulose film is suitable. In addition, when transparent protective films are provided on both sides of the polarizer, transparent protective films comprising same polymer material may be used on both of a front side and a back side, and transparent protective films comprising different polymer materials etc. may be used.

Moreover, as is described in Japanese Patent Laid-Open Publication No. 2001-343529 (WO 01/37007), polymer films, for example, resin compositions including (A) thermoplastic resins having substituted and/or non-substituted imido group is in side chain, and (B) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used.

Moreover, it is preferable that the transparent protective film may have as little coloring as possible. Accordingly, a protective film having a phase difference value in a film thickness direction represented by Rth=[(nx+ny)/2−nz]×d of −90 nm through +75 nm (where, nx and ny represent principal indices of refraction in a film plane, nz represents refractive index in a film thickness direction, and d represents a film thickness) may be preferably used. Thus, coloring (optical coloring) of polarizing plate resulting from a protective film may mostly be cancelled using a protection film having a phase difference value (Rth) of −90 nm through +75 nm in a thickness direction. The phase difference value (Rth) in a thickness direction is preferably −80 nm through +60 nm, and especially preferably −70 nm through +45 nm.

As a protective film, if polarization property and durability are taken into consideration, cellulose based polymer, such as triacetyl cellulose, is preferable, and especially triacetyl cellulose film is suitable. In addition, when the protective films are provided on both sides of the polarizer, the protective films comprising same polymer material may be used on both of a front side and a back side, and the protective films comprising different polymer materials etc. may be used. Adhesives are used for adhesion processing of the above described polarizer and the protective film. As adhesives, isocyanate derived adhesives, polyvinyl alcohol derived adhesives, gelatin derived adhesives, vinyl polymers derived latex type, aqueous polyurethane based adhesives, aqueous polyesters derived adhesives, etc. may be mentioned.

A hard coat layer may be prepared, or antireflection processing, processing aiming at sticking prevention, diffusion or anti glare may be performed onto the face on which the polarizing film of the above described protective film has not been adhered.

A hard coat processing is applied for the purpose of protecting the surface of the polarization plate from damage, and this hard coat film may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarization plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarization plate to disturb visual recognition of transmitting light through the polarization plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight part to the transparent resin 100 weight part that forms the fine concavo-convex structure on the surface, and preferably 5 to 25 weight part. An anti glare layer may serve as a diffusion layer (viewing angle expanding function etc.) for diffusing transmitting light through the polarization plate and expanding a viewing angle etc.

In addition, the above-mentioned antireflection layer, sticking prevention layer, diffusion layer, anti glare layer, etc. may be built in the protective film itself, and also they may be prepared as an optical layer different from the protective film.

An optical film of the invention may be used in practical use as a polarizing plate laminated with other optical layers. Although there is especially no limitation about the optical layers, one layer or two layers or more of optical layers, which may be used for formation of a liquid crystal display etc., such as a reflective plate, a transflective plate, a retardation plate (a half wavelength plate and a quarter wavelength plate included), and a viewing angle compensation film, may be used. Especially preferable polarizing plates are; a reflection type polarization plate or a transflective type polarization plate in which a reflective plate or a transfilective reflective plate is further laminated onto a polarizing plate of the present invention; an elliptically polarizing plate or a circular polarizing plate in which a retardation plate is further laminated onto the polarizing plate; a wide viewing angle polarization plate in which a viewing angle compensation film is further laminated onto the polarizing plate; or a polarizing plate in which a brightness enhancement film is further laminated onto the polarizing plate.

A reflective layer is prepared on a polarization plate to give a reflection type polarization plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarization plate may be formed using suitable methods, such as a method in which a reflective layer of metal etc. is, if required, attached to one side of a polarization plate through a transparent protective layer etc.

As an example of a reflection type polarization plate, a plate may be mentioned on which, if required, a reflective layer is formed using a method of attaching a foil and vapor deposition film of reflective metals, such as aluminum, to one side of a matte treated protective film. Moreover, a different type of plate with a fine concavo-convex structure on the surface obtained by mixing fine particle into the above-mentioned protective film, on which a reflective layer of concavo-convex structure is prepared, may be mentioned. The reflective layer that has the above-mentioned fine concavo-convex structure diffuses incident light by random reflection to prevent directivity and glaring appearance, and has an advantage of controlling unevenness of light and darkness etc. Moreover, the protective film containing the fine particle has an advantage that unevenness of light and darkness may be controlled more effectively, as a result that an incident light and its reflected light that is transmitted through the film are diffused. A reflective layer with fine concavo-convex structure on the surface effected by a surface fine concavo-convex structure of a protective film may be formed by a method of attaching a metal to the surface of a transparent protective layer directly using, for example, suitable methods of a vacuum evaporation method, such as a vacuum deposition method, an ion plating method, and a sputtering method, and a plating method etc.

Instead of a method in which a reflection plate is directly given to the protective film of the above-mentioned polarization plate, a reflection plate may also be used as a reflective sheet constituted by preparing a reflective layer on the suitable film for the transparent film. In addition, since a reflective layer is usually made of metal, it is desirable that the reflective side is covered with a protective film or a polarization plate etc. when used, from a viewpoint of preventing deterioration in reflectance by oxidation, of maintaining an initial reflectance for a long period of time and of avoiding preparation of a protective layer separately etc.

In addition, a transflective type polarizing plate may be obtained by preparing the above-mentioned reflective layer as a transflective type reflective layer, such as a half-mirror etc. that reflects and transmits light. A transfiective type polarization plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transflective type polarization plate. That is, the transfilective type polarization plate is useful to obtain of a liquid crystal display of the type that saves energy of light sources, such as a back light, in a well-lighted atmosphere, and can be used with a built-in light source if needed in a comparatively dark atmosphere etc.

The above-mentioned polarization plate may be used as elliptically polarization plate or circularly polarization plate on which the retardation plate is laminated. A description of the above-mentioned elliptically polarization plate or circularly polarization plate will be made in the following paragraph. These polarization plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarization plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarization plate in which three-dimensional refractive index is controlled may also preferably compensate (prevent) coloring produced when a screen of a liquid crystal display is viewed from an oblique direction. Circularly polarization plate is effectively used, for example, when adjusting a color tone of a picture of a reflection type liquid crystal display that provides a colored picture, and it also has function of antireflection.

As retardation plates, birefringence films obtained by uniaxial or biaxial stretching high polymer materials, oriented films of liquid crystal polymers, and materials in which orientated layers of liquid crystal polymers are supported with films may be mentioned. Although a thickness of a retardation plate also is not especially limited, it is in general approximately 20 through 150 μm.

As high polymer materials, for example, polyvinyl alcohols, polyvinyl butyrals, polymethyl vinyl ethers, poly hydroxyethyl acrylates, hydroxyethyl celluloses, hydroxypropyl celluloses, methyl celluloses, polycarbonates, polyarylates, polysulfones, polyethylene terephthalates, polyethylene naphthalates, polyethersulfones, polyphenylene sulfides, polyphenylene oxides, polyallyl sulfones, polyvinyl alcohols, polyamides, polyimides, polyolefins, polyvinyl chlorides, cellulose type polymers, or bipolymers, terpolymers, graft copolymers, blended materials of the above-mentioned polymers may be mentioned. These polymer raw materials make oriented materials (stretched film) using a stretching process and the like.

As liquid crystalline polymers, for example, various kinds of polymers of principal chain type and side chain type in which conjugated linear atomic groups (mesogens) demonstrating liquid crystalline orientation are introduced into a principal chain and a side chain may be mentioned. As examples of principal chain type liquid crystalline polymers, polymers having a structure where mesogen groups are combined by spacer parts demonstrating flexibility, for example, polyester based liquid crystalline polymers of nematic orientation property, discotic polymers, cholesteric polymers, etc. may be mentioned. As examples of side chain type liquid crystalline polymers, polymers having polysiloxanes, polyacrylates, polymethacrylates, or polymalonates as a principal chain skeleton, and polymers having mesogen parts comprising para-substituted ring compound units providing nematic orientation property as side chains via spacer parts comprising conjugated atomic groups may be mentioned. These liquid crystalline polymers, for example, is obtained by spreading a solution of a liquid crystal polymer on an orientation treated surface where rubbing treatment was performed to a surface of thin films, such as polyimide and polyvinyl alcohol, formed on a glass plate and or where silicon oxide was deposited by an oblique evaporation method, and then by heat-treating.

A retardation plate may be a retardation plate that has a proper retardation according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

The above-mentioned elliptically polarization plate and an above-mentioned reflected type elliptically polarization plate are laminated plate combining suitably a polarization plate or a reflection type polarization plate with a retardation plate. This type of elliptically polarization plate etc. may be manufactured by combining a polarization plate (reflected type) and a retardation plate, and by laminating them one by one separately in the manufacture process of a liquid crystal display. On the other hand, the polarization plate in which lamination was beforehand carried out and was obtained as an optical film, such as an elliptically polarization plate, is excellent in a stable quality, a workability in lamination etc., and has an advantage in improved manufacturing efficiency of a liquid crystal display.

A viewing angle compensation film is a film for extending viewing angle so that a picture may look comparatively clearly, even when it is viewed from an oblique direction not from vertical direction to a screen. As such a viewing angle compensation retardation plate, in addition, a film having birefringence property that is processed by uniaxial stretching or orthogonal bidirectional stretching and a bidriectionally stretched film as inclined orientation film etc. may be used. As inclined orientation film, for example, a film obtained using a method in which a heat shrinking film is adhered to a polymer film, and then the combined film is heated and stretched or shrinked under a condition of being influenced by a shrinking force, or a film that is oriented in oblique direction may be mentioned. The viewing angle compensation film is suitably combined for the purpose of prevention of coloring caused by change of visible angle based on retardation by liquid crystal cell etc. and of expansion of viewing angle with good visibility.

Besides, a compensation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visability.

The polarization plate with which a polarization plate and a brightness enhancement film are adhered together is usually used being prepared in a backside of a liquid crystal cell. A brightness enhancement film shows a characteristic that reflects linearly polarization light with a predetermined polarization axis, or circularly polarization light with a predetermined direction, and that transmits other light, when natural light by back lights of a liquid crystal display or by reflection from a back-side etc., comes in. The polarization plate, which is obtained by laminating a brightness enhancement film to a polarization plate, thus does not transmit light without the predetermined polarization state and reflects it, while obtaining transmitted light with the predetermined polarization state by accepting a light from light sources, such as a backlight. This polarization plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarization plate simultaneously supplies polarized light that is difficult to be absorbed in a polarizer, and increases the quantity of the light usable for a liquid crystal picture display etc., and as a result luminosity may be improved. That is, in the case where the light enters through a polarizer from backside of a liquid crystal cell by the back light etc. without using a brightness enhancement film, most of the light, with a polarization direction different from the polarization axis of a polarizer, is absorbed by the polarizer, and does not transmit through the polarizer. This means that although influenced with the characteristics of the polarizer used, about 50 percent of light is absorbed by the polarizer, the quantity of the light usable for a liquid crystal picture display etc. decreases so much, and a resulting picture displayed becomes dark. A brightness enhancement film does not enter the light with the polarizing direction absorbed by the polarizer into the polarizer but reflects the light once by the brightness enhancement film, and further makes the light reversed through the reflective layer etc. prepared in the backside to re-enter the light into the brightness enhancement film. By this above-mentioned repeated operation, only when the polarization direction of the light reflected and reversed between the both becomes to have the polarization direction which may pass a polarizer, the brightness enhancement film transmits the light to supply it to the polarizer. As a result, the light from a backlight may be efficiently used for the display of the picture of a liquid crystal display to obtain a bright screen.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, an aligned film of cholesteric liquid-crystal polymer; a film that has the characteristics of reflecting a circularly polarized light with either left-handed or right-handed rotation and transmitting other light, etc. may be mentioned.

Therefore, in the brightness enhancement film of a type that transmits a linearly polarized light having the above-mentioned predetermined polarization axis, by arranging the polarization axis of the transmitted light and entering the light into a polarization plate as it is, the absorption loss by the polarization plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light region, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarization plate and a brightness enhancement film may consist of one or more retardation layers.

In addition, also in a cholesteric liquid-crystal layer, a layer reflecting a circularly polarized light in a wide wavelength ranges, such as a visible-light region, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarization plate may consist of multi-layered film of laminated layers of a polarization plate and two of more of optical layers as the above-mentioned separated type polarization plate. Therefore, a polarization plate may be a reflection type elliptically polarization plate or a semi-transmission type elliptically polarization plate, etc. in which the above-mentioned reflection type polarization plate or a transflective type polarization plate is combined with above described retardation plate respectively.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

Formation methods of the anchor layer 2 to the above-mentioned optical film 1 is not especially limited, and for example, a method of applying a resin emulsion to an optical film 1, and then drying etc. may be mentioned. In formation of the anchor layer 2, activation treatment may be performed to the optical film 1. Various methods may be adopted as activation treatment, and, for example, a corona treatment, a low-pressure UV treatment, a plasma treatment, etc. may be adopted. Activation treatment is effective especially in the case where the optical film 1 is of polyolefine based resins or norbornene based resins. When a contact angle between water and each film is controlled to be not more than 80°, and preferably not more than 75°, repelling may be suppressed during coating of anchor agents. A thickness of the anchor layer 2 (dried film thickness) is, as mentioned above, preferably not less than twice a mean particle diameter (a) of the resin emulsion. In addition, FIG. 2 is an enlarged view concerning the anchor layer 2 in FIG. 1, and shows a case where a thickness of the anchor layer 2 is about 4 times the mean particle diameter (a) of the resin emulsion. Although a thickness of the anchor layer 2 is not especially limited, but it is preferably not less than 100 nm as described above.

The pressure sensitive adhesive layer 3 is formed by being laminated on the anchor layer 2. Formation methods are not especially limited, but there may be mentioned: a method of applying a pressure sensitive adhesive (solution) on an anchor layer 2, and then drying; and a method of transferring a layer using a releasing sheet 4 having a pressure sensitive adhesive layer 3 provided thereon etc. Although a thickness of a pressure sensitive adhesive layer 3 (dried film thickness) is not especially limited, it is preferably about 10 to 40 μm.

As a separator 4 material, papers, plastics films such as polyethylene polypropylene, rubber sheets, cloths, no woven fabrics, nets, foamed sheets and metallic foils or laminated sheets thereof may be used. As a surface of the separator 4, if necessary, suitable conventional release agents, such as silicone type, long chain alkyl type, fluorine type release agents, is coated.

In addition, in the present invention, ultraviolet absorbing property may be given to the above-mentioned each layer, such as an optical film etc. and an adhesive layer, using a method of adding UV absorbents, such as salicylic acid ester type compounds, benzophenol type compounds, benzotriazol type compounds, cyano acrylate type compounds, and nickel complex salt type compounds.

Suitable liquid crystal displays, such as liquid crystal display with which the above-mentioned optical film has been located at one side or both sides of the liquid crystal cell, and with which a backlight or a reflective plate is used for a lighting system may be manufactured. In this case, the optical film by the present invention may be installed in one side or both sides of the liquid crystal cell. When installing the optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display) will be explained. Generally, in organic EL display, a transparent electrode, an organic luminescence layer and a metal electrode are laminated on a transparent substrate in an order configuring an emitting (organic electro luminescence emitting). Here, a organic luminescence layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

An organic EL display emits light based on a principle that positive hole and electron are injected into an organic luminescence layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in a intermediate process is the same as a mechanism in common diodes, and, as is expected, there is a strong non-linear relationship between electric current and luminescence strength accompanied by rectification nature to applied voltage.

In an organic EL display, in order to take out luminescence in an organic luminescence layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display of such a configuration, an organic luminescence layer is formed by a very thin film about 10 nm in thickness. For this reason, light is transmitted nearly completely through organic luminescence layer as through transparent electrode. Consequently, since the light that enters, when light is not emitted, as incident light from a surface of a transparent substrate and is transmitted through a transparent electrode and an organic luminescence layer and then is reflected by a metal electrode, appears in front surface side of the transparent substrate again, a display side of the organic EL display looks like mirror if viewed from outside.

In an organic EL display containing an organic electro luminescence emitting equipped with a transparent electrode on a surface side of an organic luminescence layer that emits light by impression of voltage, and at the same time equipped with a metal electrode on a back side of organic luminescence layer, a retardation plate may be installed between these transparent electrodes and a polarization plate, while preparing the polarization plate on the surface side of the transparent electrode.

Since the retardation plate and the polarization plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarization plate and the retardation plate is adjusted to π/4, the mirror surface of the metal electrode may be completely covered.

This means that only linearly polarized light component of the external light that enters as incident light into this organic EL display is transmitted with the work of polarization plate. This linearly polarized light generally gives an elliptically polarized light by the retardation plate, and especially the retardation plate is a quarter wavelength plate, and moreover when the angle between the two polarization directions of the polarization plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarization plate, it cannot be transmitted through the polarization plate. As the result, mirror surface of the metal electrode may be completely covered.

### EXAMPLE

Although concrete description will be given hereinafter with reference to Examples of the present invention, the present invention is not limited to them. In addition, part represents part by weight in each example.

### Example 1

(Production of an Optical Film)

After a polyvinyl alcohol film with a thickness of 80 μm was stretched 5 times in 40° C. iodine aqueous solution, it was dried for 4 minutes at 50° C. to obtain a polarizer. Triacetyl cellulose films were adhered on both sides of this polarizer through a polyvinyl alcohol based adhesive to obtain a polarizing plate.

(Formation of an anchor layer)

A solution diluted into 5% of a solid content was prepared by dissolving Adeka Bontighter HUX 290H (an emulsion mean particle diameter of about 42 nm) manufactured by Asahi Denka Co., Ltd., as a resin emulsion of a polyurethane, with a mixed solvent of water: butyl cellosolve=3: 1 (volume ratio). This solution was applied on the polarizing plate using a wire bar #5, and, subsequently volatile matter was evaporated off. Observation by a TEM ultrathin membrane section method of a thickness of the anchor layer after evaporated gave a thickness of 1000 nm, and showed that 6 to 7 emulsion particles existed in a thickness direction.

(Formation of Pressure Sensitive Adhesive Layer)

As a base polymer, a solution (30% of solid content) including an acrylic polymer of a weight average molecular weight of 2,000,000 consisting of a copolymer of butyl acrylate : acrylic acid: 2-hydroxy ethyl acrylate =100:5:0.1 (weight ratio) was used. Into the acrylic polymer solution were added Coronate L manufactured by Nippon Polyurethane Co., Ltd. that is an isocyanate based polyfunctional compound 3.2 parts to 100 parts of a polymer solid content, an additive (manufactured by Shin-Etsu Chemical Co., Ltd., KBM 403) 0.6 parts, and a solvent for viscosity adjustment (ethyl acetate), to prepare a pressure sensitive adhesive solution (11% of solid content). The pressure sensitive adhesive solution concerned was applied on a releasing film (polyethylene terephthalate based material=Diafoil MRF 38, manufactured by Mitsubishi Polyester Film Corporation) so that a thickness after dried might gives 25 μm, and subsequently dried in a circulating hot air type oven to form a pressure sensitive adhesive layer.

(Production of a Pressure Sensitive Adhesive Optical Film)

To an anchor layer formed on a surface of the polarizing plate, a releasing film having a pressure sensitive adhesive layer currently formed thereon was attached to produce a pressure sensitive adhesive polarizing plate.

### Example 2

(An Optical Film)

Corona treatment was given to a retardation plate (100 μm) using a biaxially stretched norbornene based resin (manufactured by JSR, Arton) (71° of an angle of contact with water), and the obtained plate was used.

(Formation of an Anchor Layer)

As a polyethylene imine addition product of acrylic/styrene based copolymer emulsion, POLYMENT SK-1000 (an emulsion mean particle diameter of about 100 nm) manufactured by NIPPON SHOKUBAI Co., Ltd. was dissolved with a mixed solvent of water:isopropyl alcohol=1:3 (volume ratio), to prepare a solution diluted into 5% of a solid content. After this solution was applied on the retardation plate using a wire bar #5, volatile matter was evaporated off. Observation by TEM ultrathin membrane section method of a thickness of the anchor layer after evaporated gave a thickness of 800 nm, and showed that 4 to 5 emulsion particles existed in a thickness direction.

(Production of a Pressure Sensitive Adhesive Optical Film)

To the anchor layer formed on a surface of the retardation plate, a releasing film having a same pressure sensitive adhesive layer as in Example 1 currently formed thereon was attached to produce a pressure sensitive adhesive retardation plate.

### Example 3

(Production of an Optical Film)

A solution obtained by dissolving flakes of a polycarbonate (PC) in methylene chloride was uniformly cast a smooth SUS board, and the obtained board was dried in a solvent atmosphere so that the surface might not have dew formation. The obtained PC film was then removed from the SUS board after sufficient drying, and then dried in a circulating hot air type oven to obtain a non-stretched film of PC (30μ). This film was stretched by 1.2 times while being heated, and corona treatment was given to obtain a PC retardation plate (73° of an angle of contact with water).

(Formation of an Anchor Layer)

An anchor layer was formed on the PC retardation plate as in Example 2. Observation by a TEM ultrathin membrane section method of a thickness of the anchor layer after evaporated gave a thickness of 800 nm, and showed that 4 to 5 emulsion particles existed in a thickness direction.

(Production of a Pressure Sensitive Adhesive Optical Film)

To an anchor layer formed on a surface of the retardation plate, a releasing film having a same pressure sensitive adhesive layer as in Example 1 currently formed thereon was attached to produce a pressure sensitive adhesive retardation plate.

### Referential Example 1

(An Optical Film)

A same polarizing plate as in Example 1 was used.

(Formation of an Anchor Layer)

As a resin emulsion of polyurethane, Adeka Bontighter HUX 290H (an emulsion mean particle diameter of about 42 nm) manufactured by Asahi Denka Co., Ltd. was dissolved with a mixed solvent of water: butyl cellosolve=3: 1 (volume ratio) to prepare a solution diluted into 0.2% of solid content. This solution was applied on the polarizing plate using a wire bar #5, and, subsequently volatile matter was evaporated off. Observation by a TEM ultrathin membrane section method of a thickness of the anchor layer after evaporated gave a thickness of the anchor layer of 80 nm after evaporated, and showed that emulsion particles was dotted and overlap of the emulsion particles could not be observed in a thickness direction.

(Production of a Pressure Sensitive Adhesive Optical Film)

A releasing film having a same pressure sensitive adhesive layer as in Example 1 currently formed thereon was attached on the anchor layer formed on a surface of the polarizing plate to produce a pressure sensitive adhesive polarizing plate.

### Referential Example 2

(An Optical Film)

A same polarizing plate as in Example 1 was used.

(Formation of a Pressure Sensitive Adhesive Layer)

As a base polymer, a solution (30% of solid content) including an acrylic polymer of a weight average molecular weight of 1,400,000 consisting of a copolymer of butyl acrylate: 2-hydroxy ethyl acrylate=100:0.5 (weight ratio) was used. Into the acrylic polymer solution were added Coronate L manufactured by Nippon Polyurethane Co., Ltd. that is an isocyanate based polyfunctional compound 5 parts to 100 parts of a polymer solid content, an additive (manufactured by Shin-Etsu Chemical Co., Ltd., KBM 403) 0.5 parts, and a solvent for viscosity adjustment (toluene), to prepare a pressure sensitive adhesive solution (10% of a solid content). The pressure sensitive adhesive solution concerned was applied on a releasing film (polyethylene terephthalate based material=Diafoil MRF 38, manufactured by Mitsubishi Polyester Film Corporation) so that a thickness after dried may give 25 μm, and subsequently dried in a circulating hot air type oven to form a pressure sensitive adhesive layer.

(Production of a Pressure Sensitive Adhesive Optical Film)

After forming an anchor layer on a surface of the polarizing plate as in Example 2, a releasing film having the pressure sensitive adhesive layer formed thereon was attached on the anchor layer to produce a pressure sensitive adhesive polarizing plate.

### Comparative Example 1

Except for not having formed an anchor layer in Example 1, a same method as in Example 1 was repeated to produce a pressure sensitive adhesive polarizing plate.

### Comparative Example 2

(An Optical Film)

A same polarizing plate as in Example 1 was used.

(Formation of an Anchor Layer)

A solution of POLYMENT NK 380 manufactured by NIPPON SHOKUBAI Co., Ltd. as a solvent type polyethylene imine based resin (ethyleneimine addition product of polyacrylic ester) was applied on the polarizing plate using a wire bar #5, and subsequently volatile matter was evaporated off. A thickness of the anchor layer after evaporated gave 100 nm.

(Production of a Pressure Sensitive Adhesive Optical Film)

To an anchor layer currently formed on a surface of the polarizing plate a releasing film having a same pressure sensitive adhesive layer as in Example 1 currently formed thereon was attached to produce a pressure sensitive adhesive polarizing plate.

### Comparative Example 3

Except for not having formed an anchor layer in Example 3, a same method as in Example 3 was repeated to produce a pressure sensitive adhesive retardation plate.

The pressure sensitive adhesive optical films obtained in the Examples and Comparative examples were evaluated for the following.

Table 1 shows the evaluation results.

(Pressure Sensitive Adhesive Omission)

A pressure sensitive adhesive optical film produced by the above method was die-cut by 25 mm×150 mm size with a Thomson blade die cut system. A cut end (25 mm width side) was contacted to a glass plate (manufactured by Corning Inc., Corning 1737) 20 consecutive times. Then, the contact end of each pressure sensitive adhesive optical film was visually checked, and evaluated according to following criteria.

Moreover, an area of the pressure sensitive adhesive omission was also evaluated.

◯: A pressure sensitive adhesive omission with a depth of not less than 150 μm not observed
Δ: A pressure sensitive adhesive omission with a depth of not less than 300 μm not observed

×: A pressure sensitive adhesive omission with a depth of not less than 300 μm observed

TABLE 1

| | | Anchor layer | | | Existence of | | |
|---|---|---|---|---|---|---|---|
| | | | | Magnification to | carboxyl | | |
| | | | | a mean particle | group of | | |
| | | | | diameter of a | pressure | Pressure sensitive | |
| | | | Thickness | resin emulsion | sensitive | adhesive omission | |
| | Optical film | Kind | (nm) | (times) | adhesive layer | Evaluation | Area (mm²) |
| Example 1 | Polarizing | *1 | 1000 | 6 to 7 | Included | ◯ | 0.1 |
| | plate | | | | | | |
| Example 2 | Retardation | *2 | 800 | 4 to 5 | Included | ◯ | 0.3 |
| | plate | | | | | | |
| Example 3 | Retardation | *2 | 800 | 4 to 5 | Included | ◯ | 0.2 |
| | plate | | | | | | |
| Referential | Polarizing | *1 | 80 | Not more than 1 | Included | Δ | 0.9 |
| Example 1 | plate | | | | | | |
| Referential | Polarizing | *2 | 800 | 4 to 5 | Not | Δ | 1.0 |
| Example 2 | plate | | | | included | | |
| Comparative | Polarizing | Not used | 0 | 0 | Included | X | 2.3 |
| Example 1 | plate | | | | | | |
| Comparative | Polarizing | *3 | 100 | — | Included | X | 1.9 |
| Example 2 | plate | | | | | | |
| Comparative | Retardation | Not used | 0 | 0 | Included | X | 3.2 |
| Example 3 | plate | | | | | | |

In Table 1:
*1: Adeka Bontighter HUX 290H manufactured by Asahi Denka Co., Ltd.,
*2: POLYMENT SK 1000 manufactured by NIPPON SHOKUBAI Co., Ltd.
*3: POLYMENT NK 380 manufactured by NIPPON SHOKUBAI Co., Ltd.

Industrial Applicability

The present invention is useful as polarizing plates, retardation plates, optical compensating films, brightness enhancement films, etc., and furthermore is useful as a pressure sensitive adhesive optical film applied to optical films laminated thereto. The invention is also suitably applicable for image viewing displays, such as liquid crystal displays, organic EL viewing displays, and PDPs.

1. A pressure sensitive adhesive optical film having a pressure sensitive adhesive layer laminated on at least one surface of the optical film, wherein the pressure sensitive adhesive layer is laminated through an anchor layer formed of a resin emulsion, and a thickness of the anchor layer is not less than twice a mean particle diameter of the resin emulsion.

2. (canceled).

3. The pressure sensitive adhesive optical film according to claim 1, wherein a thickness of the anchor layer is not less than 100 nm.

4. The A pressure sensitive adhesive optical film having a pressure sensitive adhesive layer laminated on at least one surface of the optical film, wherein the pressure sensitive adhesive layer is laminated through an anchor layer formed of a resin emulsion, the resin emulsion is of an ethyleneimine addition product and/or a polyethylene imine addition product of an acrylic based polymer emulsion, and a base polymer of the pressure sensitive adhesive for forming the pressure sensitive adhesive layer includes a functional group reactive with an amino group.

5. The pressure sensitive adhesive optical film according to claim 4, wherein a functional group reactive with an amino group included in the base polymer of the pressure sensitive adhesive for forming the pressure sensitive adhesive layer is of a carboxyl group.

6. The pressure sensitive adhesive optical film according to claim 5, wherein the acrylic based polymer emulsion is an acrylic/styrene based copolymer emulsion.

7. The pressure sensitive adhesive optical film according to claim 1, wherein the resin emulsion is an emulsion of a polyurethane resin.

8. The pressure sensitive adhesive optical film according to claim 7, wherein a glass transition temperature of the polyurethane resin is not more than −30° C.

9. The pressure sensitive adhesive optical film according to claim 1, wherein activation treatment is given to the optical film.

10. An image viewing display using the at least one pressure sensitive adhesive optical film according to claim 1.

11. The pressure sensitive adhesive optical film according to claim 4, wherein a thickness of the anchor layer is not less than twice a mean particle diameter of the resin emulsion.

12. The pressure sensitive adhesive optical film according to claim 4, wherein a thickness of the anchor layer is not less than 100 nm.

13. The pressure sensitive adhesive optical film according to claim 4, wherein activation treatment is given to the optical film.

14. An image viewing display using the at least one pressure sensitive adhesive optical film according to claim 4.
